(19) United States
(12) Patent Application Publication
(10) Pub. No.: US 2024/0214880 A1
(43) Pub. Date: Jun. 27, 2024

(54) METHOD AND APPARATUS FOR CELL SELECTION IN COMMUNICATION

(71) Applicant: Electronics and Telecommunications Research Institute, Daejeon (KR)

(72) Inventor: Mi Young YUN, Daejeon (KR)

(21) Appl. No.: 18/391,010

(22) Filed: Dec. 20, 2023

(30) Foreign Application Priority Data
Dec. 23, 2022 (KR) 10-2022-0183533
May 12, 2023 (KR) 10-2023-0061980
Dec. 11, 2023 (KR) 10-2023-0179129

(51) Int. Cl. H04W 36/00; H04W 24/10

(52) U.S. Cl. CPC H04W 36/0061; H04W 24/10; H04W 36/0085; H04W 84/06

(57) ABSTRACT

A method of a terminal may comprise: obtaining, from a non-terrestrial base station, terrestrial service area information for application of a cell measurement relaxation method; receiving neighbor cell information from the non-terrestrial base station; identifying a measurement target neighbor cell based on the neighbor cell information; determining information on a service area of the measurement target neighbor cell based on the terrestrial service area information; and triggering cell measurement based on a location of the terminal and the information on the service area of the measurement target neighbor cell.

### CROSS-REFERENCE TO RELATED APPLICATIONS

This application claims priority to Korean Patent Applications No. 10-2022-0183533, filed on Dec. 23, 2022, No. 10-2023-0061980, filed on May 12, 2023, and No. 10-2023-0179129, filed on Dec. 11, 2023, with the Korean Intellectual Property Office (KIPO), the entire contents of which are hereby incorporated by reference.

### BACKGROUND

### 1. Technical Field

Exemplary embodiments of the present disclosure relate to a cell selection technique in a communication system, and more specifically, to a cell selection technique in a communication system, which triggers measurement on terrestrial cells when a terminal approaches close to a terrestrial service area.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, such the communication network may provide communication services to terminals located in terrestrial sites, and may be a terrestrial network. Recently, the demand for communication services for airplanes, drones, satellites, etc. located not only in the terrestrial sites but also in non-terrestrial spaces is increasing. The size of a cell in a non-terrestrial network may be relatively large compared to the size of a cell in a terrestrial network. Accordingly, terrestrial cells may exist locally in a non-terrestrial cell. When terrestrial cells and a non-terrestrial cell coexist at the same frequency or different frequencies, a terminal can measure both the terrestrial cells and the non-terrestrial cell in measuring neighbor cells for cell selection and reselection. In this case, if the terminal exists in a non-terrestrial cell that is not adjacent to terrestrial cells, unnecessary cell measurements may be repeatedly performed. Accordingly, the power consumption of the terminal may increase.

### SUMMARY

Exemplary embodiments of the present disclosure are directed to providing a method and an apparatus for cell selection in a communication system, which trigger measurement on terrestrial cells when a terminal approaches close to a terrestrial service area.

According to a first exemplary embodiment of the present disclosure, a method of a terminal may comprise: obtaining, from a non-terrestrial base station, terrestrial service area information for application of a cell measurement relaxation method; receiving neighbor cell information from the non-terrestrial base station; identifying a measurement target neighbor cell based on the neighbor cell information; determining information on a service area of the measurement target neighbor cell based on the terrestrial service area information; and triggering cell measurement based on a location of the terminal and the information on the service area of the measurement target neighbor cell.

The obtaining of the terrestrial service area information may comprise: receiving, from the non-terrestrial base station, a system information block (SIB) including the terrestrial service area information for application of the cell measurement relaxation method; and obtaining the terrestrial service area information from the SIB.

The obtaining of the terrestrial service area information may comprise: receiving, from the non-terrestrial base station, a signal including the terrestrial service area information for application of the cell measurement relaxation method through a dedicated channel; and obtaining the terrestrial service area information from the signal.

The method may further comprise, before the receiving of the signal including the terrestrial service area information, receiving, from the non-terrestrial base station, support indication information indicating that the cell measurement relaxation method is supported and transmitting, to the non-terrestrial base station, terminal capability information indicating that the terminal supports the cell measurement relaxation method.

The neighbor cell information may include identification information of each neighbor cell and information on a priority of each neighbor cell, and the identifying of the measurement target neighbor cell may comprise: identifying a priority of a frequency used by the non-terrestrial base station; and identifying a neighbor cell using a frequency with a higher priority than the priority of the frequency used by the non-terrestrial base station from the neighbor cell information as the measurement target neighbor cell.

The method may further comprise, when the neighbor cell information includes cell type information of each neighbor cell, obtaining cell type information of the measurement target neighbor cell, wherein the determining of the information on the service area of the measurement target neighbor cell may be performed when the obtained cell type information of the measurement target neighbor cell indicates that the measurement target neighbor cell is a terrestrial cell.

The method may further comprise, when the neighbor cell information includes information on service areas for neighbor cells that are terrestrial cells, searching for information on the service area of the measurement target neighbor cell from the neighbor cell information, wherein the determining of the information on the service area of the measurement target neighbor cell may be performed when the information on the service area of the measurement target neighbor cell is searched.

The terrestrial service area information may include identification information of each terrestrial service area, information on a center location of each terrestrial service area, information on a radius of each terrestrial service area, and information on a threshold of each terrestrial service area, and the triggering of the cell measurement may comprise: determining the location of the terminal; determining a center location, radius, and threshold of the terrestrial service area information related to the measurement target neighbor cell; determining whether the location of the terminal is within the threshold from the center location of the service area related to the measurement target neighbor cell, based on the center location and radius of the terrestrial service area information related to the measurement target neighbor cell; and triggering the cell measurement when the location of the terminal is within the threshold from the center location of the service area related to the measurement target neighbor cell.

The threshold may be a threshold distance or a threshold altitude.

The threshold altitude may be a fixed threshold altitude that is fixed regardless of a distance from the central location of the service area, or a variable threshold altitude that varies depending on the distance from the central location of the service area.

In the triggering of the cell measurement, cell measurement may be skipped when the terminal is not located in or close to the service area related to the measurement target neighbor cell and is in an idle state or inactive state.

According to a second exemplary embodiment of the present disclosure, a method of a non-terrestrial base station may comprise: transmitting, to a terminal, terrestrial service area information including information on a service area of a measurement target neighbor cell for application of a cell measurement relaxation method; transmitting, to the terminal, neighbor cell information including information on the measurement target neighbor cell; and receiving, from the terminal, a measurement result measured for the measurement target neighbor cell based on the terrestrial service area information and the neighbor cell information.

The non-terrestrial base station may transmit the terrestrial service area information for application of the cell measurement relaxation method to the terminal through a system information block (SIB).

The method may further comprise: transmitting, to the terminal, support indication information indicating that the cell measurement relaxation method is supported; and receiving, from the terminal, terminal capability information indicating that the terminal supports the cell measurement relaxation method, wherein the non-terrestrial base station transmits the terrestrial service area information for application of the cell measurement relaxation method to the terminal through a dedicated channel.

The terrestrial service area information may include identification information of each terrestrial service area, information on a center location of each terrestrial service area, information on a radius of each terrestrial service area, and information on a threshold of each terrestrial service area.

The neighbor cell information may include at least one of cell identification information for each neighbor cell, non-terrestrial cell indication information for each neighbor cell, terrestrial cell indication information for each neighbor cell, information on a service area to which each neighbor cell belongs, information on a frequency for each neighbor cell, information on an operator for each neighbor cell, or information on a priority for each neighbor cell.

According to a third exemplary embodiment of the present disclosure, a terminal may comprise a processor, and the processor may cause the terminal to perform: obtaining, from a non-terrestrial base station, terrestrial service area information for application of a cell measurement relaxation method; receiving neighbor cell information from the non-terrestrial base station; identifying a measurement target neighbor cell based on the neighbor cell information; determining information on a service area of the measurement target neighbor cell based on the terrestrial service area information; and triggering cell measurement based on a location of the terminal and the information on the service area of the measurement target neighbor cell.

In the obtaining of the terrestrial service area information, the processor may further cause the terminal to perform: receiving, from the non-terrestrial base station, a system information block (SIB) including the terrestrial service area information for application of the cell measurement relaxation method; and obtaining the terrestrial service area information from the SIB.

In the obtaining of the terrestrial service area information, the processor may further cause the terminal to perform: receiving, from the non-terrestrial base station, a signal including the terrestrial service area information for application of the cell measurement relaxation method through a dedicated channel; and obtaining the terrestrial service area information from the signal.

In the triggering of the cell measurement, the processor may further cause the terminal to skip cell measurement when the terminal is not located in or close to the service area related to the measurement target neighbor cell and is in an idle state or inactive state.

According to the present disclosure, the terminal can trigger measurement on terrestrial cells when the terminal approaches a terrestrial service area. Additionally, according to the present disclosure, the terminal can reduce power consumption by triggering cell measurement when the terminal approaches a terrestrial service area.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of a coexistence state of a non-terrestrial cell and terrestrial cells.

FIG. 5 is a conceptual diagram illustrating a second exemplary embodiment of a coexistence state of a non-terrestrial cell and terrestrial cells.

FIG. 6 is a conceptual diagram illustrating a third exemplary embodiment of a coexistence state of a non-terrestrial cell and terrestrial cells.

FIG. 7 is a conceptual diagram illustrating a fourth exemplary embodiment of a coexistence state of a non-terrestrial cell and terrestrial cells.

FIG. 8 is a conceptual diagram illustrating a fifth exemplary embodiment of a coexistence state of a non-terrestrial cell and terrestrial cells.

FIG. 9 is a flow chart illustrating a first exemplary embodiment of a cell selection method in a communication system.

FIG. 10 is a sequence chart illustrating a first exemplary embodiment of a method for obtaining the terrestrial service area information of FIG. 9.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g., long-term evolution (LTE) communication network), a 5G communication network (e.g., new radio (NR) communication network), a 6G communication network, or the like. The 4G communication network, 5G communication network, and 5G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

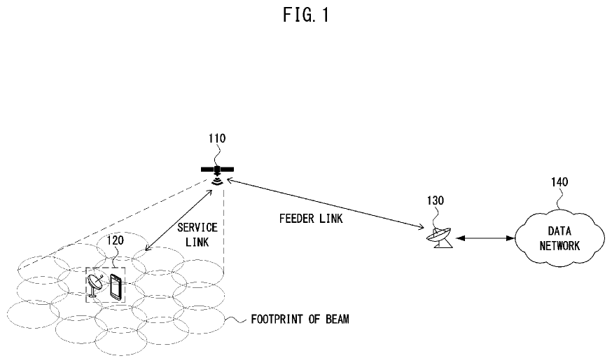

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g., a user equipment (UE) or a terminal) located on a terrestrial site and a communication node (e.g., an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g., downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g., base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g., AMF, UPF, SMF, and the like) may be performed based on an NG-C/U interface.

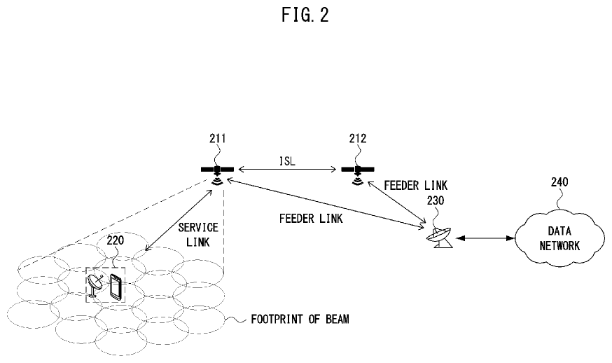

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g., base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g., AMF, UPF, SMF, and the like) may be performed based on an NG-C/U interface.

Meanwhile, entities (e.g., satellites, communication nodes, gateways, etc.) constituting the NTNs shown in FIGS. 1 and 2 may be configured as follows.

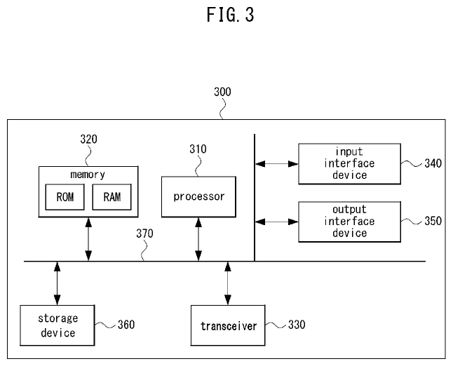

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g., a GEO satellite that supports a transparent function), this may be referred to as ‘scenario A’. When the satellites 211 and 212 in the NTN shown in FIG. 2 are GEO satellites (e.g., GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D |
|---|---|---|---|
| Altitude | 35,786 | km | 600 km |
| | | | 1,200 km |
| Spectrum (service link) | <6 GHz (e.g. 2 GHz) | | |
| | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance between | 40,581 | km | 1,932 km (altitude of |
| satellite and communication | | | 600 km) |
| node (e.g. UE) at the | | | 3,131 km (altitude of |
| minimum elevation angle | | | 1,200 km) |
| Maximum round trip delay | Scenario A: 541.46 ms | | Scenario C: (transparent |
| (RTD) | (service and feeder links) | | payload: service and feeder |
| (only propagation delay) | Scenario B: 270.73 ms (only | | links) −5.77 ms (altitude |
| | service link) | | of 60 0 km) −41.77 ms |
| | | | (altitude of 1,200 km) |
| | | | Scenario D: (regenerative |
| | | | payload: only service |
| | | | link) −12.89 ms (altitude |
| | | | of 600 km) −20.89 ms |
| | | | (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |

| | |
|---|---|
| within a cell | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

Meanwhile, in a three-dimensional space mobile communication system considered in the present disclosure, a mobile communication base station can provide mobile communication services to terminals in the air as well as on the ground using a moving object in the air. Here, the moving object in the air may be urban air mobility (UAM), drone, aircraft, satellite, or the like. In addition, the terminal in the air may be a handheld terminal, fixed terminal, or aerial vehicle. As another example, in the three-dimensional space mobile communication system, a base station on the ground (i.e. terrestrial base station) can provide mobile communication services to terminals in the air.

In a network scenario considered in the present disclosure, a mobile communication base station may configure a cell from a node in the air toward the ground. Alternatively, in a network scenario considered in the present disclosure, a terrestrial base station may configure a cell in the air by steering antennas towards the aerial direction. In the present disclosure, this type of cell may be described as a non-terrestrial cell. Additionally, similarly to cell configurations of the existing mobile communication system, a terrestrial base station may configure a cell in the ground direction. In the present disclosure, this type of cell may be described as a terrestrial cell. With these various cell types, the base station can provide mobile communication services not only to terminals located on the ground but also to terminals in the air.

The size of the non-terrestrial cell may be relatively large compared to the size of the terrestrial cell in the existing terrestrial communication. Accordingly, terrestrial cells may exist locally within a non-terrestrial cell with a large cell size.

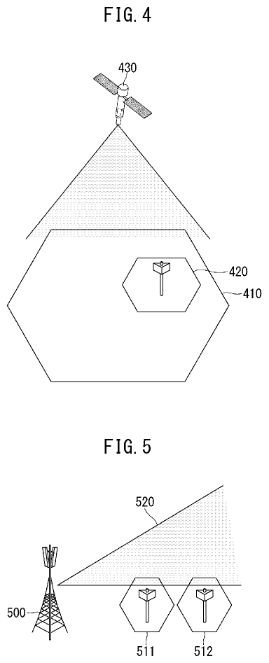

FIG. 4 is a conceptual diagram illustrating a first exemplary embodiment of a coexistence state of a non-terrestrial cell and terrestrial cells.

Referring to FIG. 4, a terrestrial cell 420 may be located within a non-terrestrial cell 410 based on a satellite 430. Accordingly, a terminal may move within the non-terrestrial cell 410 and approach close to the terrestrial cell 420.

FIG. 5 is a conceptual diagram illustrating a second exemplary embodiment of a coexistence state of a non-terrestrial cell and terrestrial cells.

Referring to FIG. 5, terrestrial cells 511 and 512 may be located within a non-terrestrial cell 520 based on a terrestrial base station 510. Accordingly, a terminal may move within the non-terrestrial cell and approach close to the terrestrial cell.

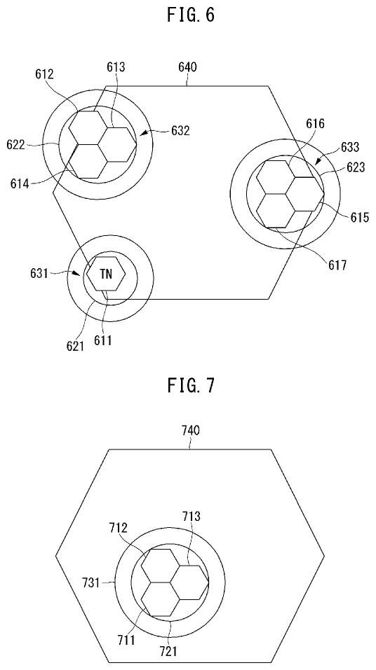

FIG. 6 is a conceptual diagram illustrating a third exemplary embodiment of a coexistence state of a non-terrestrial cell and terrestrial cells.

Referring to FIG. 6, a terrestrial cell 611 may be located solely in a boundary region of a satellite-based non-terrestrial cell 640. Terrestrial cells 612 to 614 may form a cluster and be located in a boundary region of the satellite-based non-terrestrial cell 640. Alternatively, terrestrial cells 615 to 617 may form another cluster and be located in a boundary region of the satellite-based non-terrestrial cell 640.

The terminal may move within the non-terrestrial cell and approach close to the terrestrial cell. The terrestrial cell 611 may alone form a first service area 621 that includes a terrestrial cell. Alternatively, the terrestrial cells 612 to 614 may form a second service area 622 including terrestrial cells as one cluster. Alternatively, the terrestrial cells 615 to 617 may form a third service area 623 including terrestrial cells as another cluster.

Meanwhile, a threshold distance may mean a predetermined distance from a center of a service area, may use a distance unit (e.g. meter (m)) as its unit, and may be a positive real number. The threshold distance may be greater than a radius of the service area. The threshold distance may be used to configure a measurement trigger region. As an example, a first measurement trigger region 631 may be farther away than a radius from the center of the first service area 621 and may mean a region within the threshold distance. In addition, a second measurement trigger region 632 may be farther away than a radius from the center of the second service area 622 and may mean a region within the threshold distance. In addition, a third measurement trigger region 633 may be farther away than a radius from the center of the third service area 623 and may mean a region within the threshold distance. Accordingly, a terminal may move to a service area via a measurement trigger region corresponding thereto while moving within the non-terrestrial cell.

FIG. 7 is a conceptual diagram illustrating a fourth exemplary embodiment of a coexistence state of a non-terrestrial cell and terrestrial cells.

Referring to FIG. 7, terrestrial cells 711 to 713 may form a cluster and be located within a satellite-based non-terrestrial cell 740. In this case, the terrestrial cells 711 to 713 may form a service area 721 including terrestrial cells as one cluster.

As described above, a threshold distance may mean a predetermined distance from a center of a service area, may use a distance unit (e.g. meter (m)) as its unit, and may be a positive real number. The threshold distance may be greater than a radius of the service area. The threshold distance may be used to configure a measurement trigger region. As an example, a measurement trigger region 731 may be farther away than a radius from the center of the service area 721 and may mean a region that may be within the threshold distance. Accordingly, a terminal may move to the service area via the measurement trigger region while moving within the non-terrestrial cell.

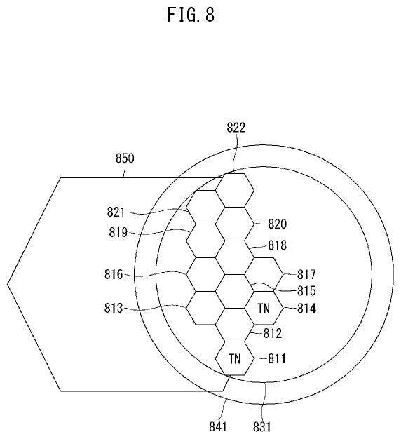

FIG. 8 is a conceptual diagram illustrating a fifth exemplary embodiment of a coexistence state of a non-terrestrial cell and terrestrial cells.

Referring to FIG. 8, terrestrial cells 811 to 822 may form a cluster and be located in a boundary region of a satellite-based non-terrestrial cell 850. The terrestrial cells 811 to 822 may form a service area 831 including terrestrial cells as one cluster. A threshold distance may mean a predetermined distance from the center of the service area 831, may use a distance unit (e.g. m) as its unit, and may be a positive real number. The threshold distance may be greater than a radius of the service area. The threshold distance may be used to configure a measurement trigger region. As an example, a measurement trigger region 841 may be farther away than the radius from the center of the first service area 831 and may mean a region that may be within the threshold distance. Accordingly, a terminal may move to the service area via the measurement trigger region while moving within the non-terrestrial cell.

Meanwhile, terrestrial cells and non-terrestrial cell(s) may coexist at the same frequency or different frequencies. In this case, the terminal may measure both terrestrial cells and non-terrestrial cells in neighbor cell measurement for cell selection and reselection. However, when a terminal is located in a non-terrestrial cell that is not adjacent to terrestrial cells, or when a terminal does not move close to terrestrial cells due to low mobility, unnecessary terrestrial cell measurements may be repeated. Accordingly, the power consumption of the terminal may increase. To solve this, when a terminal is located in a non-terrestrial cell that is not adjacent to terrestrial cells, terrestrial cell measurements may be skipped. Alternatively, when a terminal is located in a non-terrestrial cell and does not move close to terrestrial cells, unnecessary terrestrial cell measurements may be skipped. Alternatively, when a terminal is located in a non-terrestrial cell and is not located in a coverage of terrestrial cells, unnecessary terrestrial cell measurements may be skipped. As described above, in order to reduce the power consumption of the terminal, the terminal may perform cell measurements at a location adjacent to terrestrial cell(s). In other words, a terminal within a non-terrestrial cell may perform cell measurement if it reaches a measurement trigger region of a service area when moving toward the service area. On the other hand, a terminal within a non-terrestrial cell may not perform cell measurement if it does not reach a measurement trigger region of a service area when moving toward the service area. In this case, the terminal may be in an idle state or inactive state.

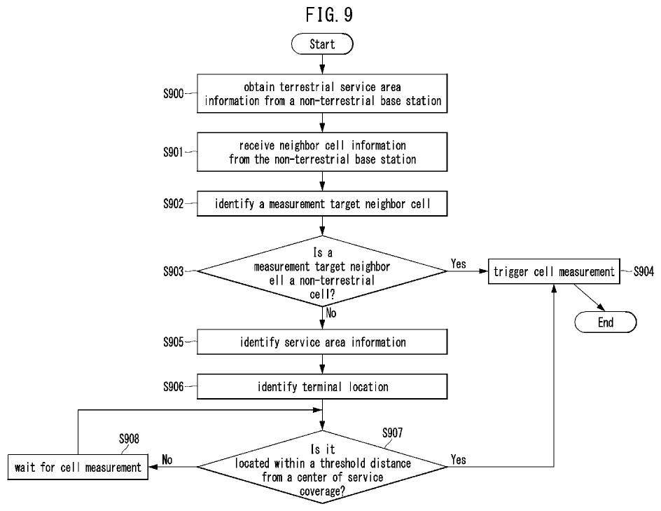

FIG. 9 is a flow chart illustrating a first exemplary embodiment of a cell selection method in a communication system.

Referring to FIG. 9, in a cell selection method, a non-terrestrial cell base station may transmit terrestrial service area information (i.e. information on service area(s) of terrestrial cell(s)) to a terminal. Then, the terminal may receive and obtain the terrestrial service area information from the non-terrestrial cell base station (S900). Here, the terrestrial service area information may include identification information of each terrestrial service area, information on a center location of each terrestrial service area, information on a radius from a center of each terrestrial service area, information on a threshold from a center location of each terrestrial service area, and/or the like. Here, the terminal may be in an idle state.

Here, the identification information of each terrestrial service area may be an identifier (ID) of each terrestrial service area, index of each terrestrial service area, or the like. In addition, the threshold may be a threshold distance in two dimensions (i.e. on the earth's surface), may use indicate a distance (e.g. meters (m), and may be a positive real number. Additionally, the threshold may include a threshold altitude in three dimensions. In this case, the threshold altitude may be a fixed threshold altitude regardless of location. Alternatively, the threshold altitude may be a variable threshold altitude that varies to decrease with a distance from the central location of the service area. The threshold altitude may be an altitude above sea level, may indicate a height, and may be a positive real number. In the present disclosure, a terrestrial service area may be expressed simply as a ‘service area’.

Accordingly, the terminal may identify, from the received terrestrial service area information, the identification information of each terrestrial service area, information on the center location of each terrestrial service area, information on the radius from the center of each terrestrial service area, information on the threshold from the center location of each terrestrial service area, and/or the like. Further, the terminal may recognize an ID of each terrestrial service area, index of each terrestrial service area, or the like.

Here, the non-terrestrial cell base station may provide the terrestrial service area information to the terminal using a system information block (SIB). At this time, the terminal may be in an idle state or inactive state. Alternatively, the non-terrestrial cell base station may provide the terrestrial service area information to the terminal using a dedicated channel. At this time, the terminal may be in a connected state. The cell selection method described with reference to FIG. 9 may be referred to as a cell measurement relaxation method between non-terrestrial cell and terrestrial cell. Alternatively, the cell selection method described with reference to FIG. 9 may be referred to simply as a cell measurement relaxation method.

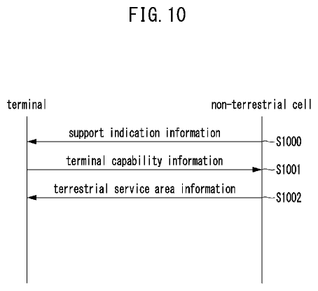

FIG. 10 is a sequence chart illustrating a first exemplary embodiment of a method for obtaining the terrestrial service area information of FIG. 9.

Referring to FIG. 10, the non-terrestrial cell base station may transmit support indication information indicating support for a cell measurement relaxation method between non-terrestrial cell and terrestrial cell to the terminal (S1000). Then, the terminal may receive the support indication information from the non-terrestrial cell base station indicating support for the cell measurement relaxation method. Accordingly, the terminal may recognize that the non-terrestrial cell base station supports the cell measurement relaxation method. At this time, the terminal may be in the connected state.

Here, the non-terrestrial cell base station may transmit a bit (i.e. support indication bit) in system information indicating support for the cell measurement relaxation method to the terminal as the support indication information. Then, the terminal may receive the system information including the support indication bit indicating support for the cell measurement relaxation method from the non-terrestrial cell base station. Accordingly, the terminal may recognize that the non-terrestrial cell base station supports the cell measurement relaxation method by detecting the support indication bit in the system information.

Accordingly, the terminal may transmit terminal capability information (i.e. UE capability information) including support indication information indicating support for the cell measurement relaxation method to the non-terrestrial cell base station (S1001). Then, the non-terrestrial cell base station may receive the terminal capability information including the support indication information indicating support for the cell measurement relaxation method from the terminal. Accordingly, the non-terrestrial cell base station may identify that the terminal also supports the cell measurement relaxation method.

When both the non-terrestrial cell base station and the terminal support the cell measurement relaxation method as described above, the non-terrestrial cell base station may transmit the terrestrial service area information to the terminal using a dedicated channel (S1002). Then, the terminal may receive the terrestrial service area information from the non-terrestrial base station through the dedicated channel.

Referring again to FIG. 9, the non-terrestrial cell base station may provide neighbor cell information (i.e. information on neighbor cell(s)) to the terminal. Then, the terminal may receive the neighbor cell information from the non-terrestrial cell base station (S901). In this case, the neighbor cell information may include cell identification information for each neighbor cell, non-terrestrial cell indication information for each neighbor cell (e.g. information indicating whether each neighbor cells is a non-terrestrial cell), terrestrial cell indication information for each neighbor cell (e.g. information indicating whether each neighbor cell is a terrestrial cell), information of a service area to which each neighbor cell belongs, information on a frequency of each neighbor cell, information on an operator for each neighbor cell, information on a priority for each neighbor cell, and/or the like.

Here, the cell identification information of each neighbor cell may be a physical cell identifier (PCI). The non-terrestrial cell indication information for each neighbor cell may be non-terrestrial cell type indication information indicating that the corresponding neighbor cell is a non-terrestrial cell. The non-terrestrial cell type indication information indicating a non-terrestrial cell may be a non-terrestrial cell type indication bit indicating a non-terrestrial cell. The terrestrial cell indication information for each neighbor cell may be terrestrial cell type indication information indicating that the corresponding neighbor cells is a terrestrial cell. The non-terrestrial cell type indication information indicating a terrestrial cell may be a terrestrial cell type indication bit indicating a terrestrial cell.

The information on the service area to which each neighbor cell belongs may be an identifier (ID) of a terrestrial service area, index of a terrestrial service area, or the like. The information on the frequency of each neighbor cell may be information indicating a frequency used by each neighbor cell. The information on the operator for each of neighbor cell may be a public terrestrial mobile network (PLMM) ID. The information on the priority for each of neighbor cell may be a priority value for the frequency of each neighbor cell.

Meanwhile, the terminal may identify measurement target neighbor cell(s) based on the priority information (S902). In other words, the terminal may identify a frequency with a higher priority than a priority of a frequency of the non-terrestrial cell base station from the priority information of the neighbor cells. Then, the terminal may recognize neighbor cell(s) with the identified frequency as the measurement target neighbor cell(s).

Then, the terminal may determine whether a cell type of the measurement target neighbor cell is a non-terrestrial cell (S903). In this case, if the terminal finds non-terrestrial cell type indication information with respect to the measurement target neighbor cell in the neighbor cell information, the terminal may determine the corresponding neighbor cell as a non-terrestrial cell. On the other hand, if the terminal finds terrestrial cell type indication information with respect to the measurement target neighbor cell in the neighbor cell information, the terminal may determine the corresponding neighbor cell as a terrestrial cell. Alternatively, the terminal may identify a frequency for the measurement target neighbor cell from the neighbor cell information, and determine the corresponding neighbor cell as a non-terrestrial cell if the frequency thereof is a frequency used by non-terrestrial cells. On the other than, the terminal may identify the frequency of the measurement target neighbor cell from the neighbor cell information, and determine the corresponding neighbor cell as a terrestrial cell if the frequency thereof is a frequency used by terrestrial cells.

Alternatively, the terminal may identify an operator for the measurement target neighbor cell from the neighbor cell information, and determine the corresponding neighbor cell as a non-terrestrial cell if the operator thereof is an operator operating non-terrestrial cells. On the other hand, the terminal may identify an operation of the measurement target neighbor cell from the neighbor cell information, and determine the corresponding neighbor cell as a terrestrial cell if the operator thereof is an operator operating terrestrial cells. Alternatively, if the terminal cannot find information on a service area to which the measurement target neighbor cell belongs in the neighbor cell information, the terminal may determine the corresponding neighbor cell as a non-terrestrial cell. On the other hand, if the terminal finds information on a service area to which the measurement target neighbor cell belongs in the neighbor cell information, the terminal may determine the corresponding neighbor cell as a terrestrial cell.

Meanwhile, the terminal may trigger cell measurement when the measurement target neighbor cell is a non-terrestrial cell (S904). However, when the measurement target neighbor is a terrestrial cell, the terminal may check information on the service area of the measurement target neighbor cell (S905). Describing this in more detail, the terminal may identify the service area of the measurement target neighbor cell, and identify the center location of the service area, radius from the center of the service area, threshold from the center location of the service area, and/or the like. Additionally, the terminal may recognize an ID of the service area, index of the service area, or the like from the information on the service area to which the measurement target neighbor cell belongs. Additionally, the terminal may identify a threshold distance, threshold altitude, and/or the like from the information on the threshold of the service area.

Meanwhile, the terminal may identify a location of the terminal based on signals received from global positioning system (GPS) satellites (S905). Then, the terminal may determine whether the terminal is located within the threshold distance from the center of the service area associated with the measurement target neighbor cell based on the information on the service area and the identified location of the terminal (S906). In other words, the terminal may identify a measurement trigger region based on the information on the service area and determine whether the terminal is located in the measurement trigger region.

As a result of the determination, the terminal may trigger cell measurement if the location of the terminal is within the threshold distance from the center of the service area associated with the measurement target neighbor cell (S904). On the other hand, if the location of the terminal is not within the threshold distance from the center of the service area associated with the measurement target neighbor cell, the terminal may not perform cell measurement, may wait, and may repeat from the step S907. In other words, based on the identified location of the terminal and measurement trigger region, if the terminal is not located in the measurement trigger region, the terminal may perform cell measurement. If not, the terminal may repeat from the step S907 while waiting without performing cell measurement.

Meanwhile, the terminal may perform cell measurement on the measurement target neighbor cell, and transmit a cell measurement results to the non-terrestrial cell. Then, the non-terrestrial cell may receive the measurement result from the terminal, and use it for a subsequent handover, and the like.

The threshold distance-based cell measurement relaxation method described above may be applied when the terminal is on the ground or at sea. However, when the terminal is a non-terrestrial terminal, the terminal may apply a measurement triggering condition based on the threshold altitude.

Describing it in more detail, the non-terrestrial terminal may determine an altitude of the terminal by using an altimeter, or the like. Then, the non-terrestrial terminal may determine whether the non-terrestrial terminal is located below the threshold altitude from the center of the service area associated with the measurement target neighbor cell based on the information on the service area and the identified altitude of the non-terrestrial terminal. As a result of the determination, the non-terrestrial terminal may trigger measurement on the measurement target neighbor cell if the altitude of the non-terrestrial terminal is below the threshold altitude from the center of the service area associated with the measurement target neighbor cell.

On the other hand, as a result of the determination, if the altitude of the non-terrestrial terminal is not below the threshold altitude from the center of the service area associated with the measurement target neighbor cell, the non-terrestrial terminal may repeat the process of determining whether the altitude of the non-terrestrial terminal is below the threshold altitude from the center of the service area associated with the measurement target neighbor cell while waiting for measurement on the measurement target neighbor cell.

As a method different from the method described above, the non-terrestrial terminal may determine the location of the non-terrestrial terminal based on signals received from GPS satellites. Thereafter, the non-terrestrial terminal may determine whether the non-terrestrial terminal is located within the threshold distance from the center of the service area associated with the measurement target neighbor cell based on the information on the service area and the identified non-terrestrial terminal location.

As a result of the determination, the non-terrestrial terminal may determine the altitude of the non-terrestrial terminal if the location of the non-terrestrial terminal is within the threshold distance from the center of the service area associated with the measurement target neighbor cell. Thereafter, the non-terrestrial terminal may determine whether the non-terrestrial terminal is located below the threshold altitude from the center of the service area associated with the measurement target neighbor cell based on the information on the service area and the identified altitude of the non-terrestrial terminal. As a result of the determination, the non-terrestrial terminal may trigger measurement on the measurement target neighbor cell if the altitude of the non-terrestrial terminal is below the threshold altitude from the center of the service area associated with the measurement target neighbor cell.

On the other hand, as a result of the determination, if the altitude of the non-terrestrial terminal is not below the threshold altitude from the center of the service area associated with the measurement target neighbor cell, the non-terrestrial terminal may repeat the process of determining whether the altitude of the non-terrestrial terminal is below the threshold altitude from the center of the service area associated with the measurement target neighbor cell while waiting for measurement on the measurement target neighbor cell.

As described above, the non-terrestrial cell base station may provide the threshold altitude as a single altitude condition for the non-terrestrial terminal. Accordingly, if the altitude of the non-terrestrial terminal becomes higher than the threshold altitude, measurements on terrestrial cells may not be performed. If the altitude of the non-terrestrial terminal falls below the threshold altitude, measurements on terrestrial cells may be performed. On the other hand, the non-terrestrial cell base station may provide a threshold altitude range consisting of a low threshold altitude and a high threshold altitude. Accordingly, when the altitude of the non-terrestrial terminal is located within the threshold altitude range, measurements on terrestrial cells may be performed.

Meanwhile, the method of mapping the terrestrial service area information and the neighbor terrestrial cell information may be as follows, as previously described.

The first method may be a method of including PCI information of neighbor terrestrial cells with regional relevance among terrestrial cells in a neighbor terrestrial cell list in the terrestrial service area information.

The second method may be a method of including index information of neighbor terrestrial cells with regional relevance among terrestrial cells in a neighbor terrestrial cell list in the terrestrial service area information.

The third method may be a method of including index information of terrestrial service area information in the neighbor terrestrial cell information.

Meanwhile, the terminal may perform measurement on neighbor terrestrial cells associated with a terrestrial service area when a serving cell is a non-terrestrial cell and the terminal approaches the terrestrial service area within a threshold distance. Then, the terminal may rank cells that satisfy a cell selection criterion and perform cell selection and reselection procedures. In case of intra-frequency cell selection and reselection and in case of inter-frequency cell selection and reselection between frequencies for the same priority, the terminal may not perform measurements on neighbor terrestrial cells if the terminal is outside the threshold distance from the terrestrial service area. When the terminal enters the terrestrial service area within the threshold distance, the terminal may trigger measurement on neighbor terrestrial cells.

In case of inter-frequency cell selection and reselection between high priority frequencies, the priority of terrestrial cells may generally be set higher in a region where both non-terrestrial cells and terrestrial cells are supported. In this case, measurement for cell selection of a high priority frequency may not be performed even if neighbor terrestrial cells with a higher priority than the non-terrestrial serving cell are configured. In this case, when the terminal enters the terrestrial service area within the threshold distance, the terminal trigger measurement on neighbor terrestrial cells.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
obtaining, from a non-terrestrial base station, terrestrial service area information for application of a cell measurement relaxation method;
receiving neighbor cell information from the non-terrestrial base station;
identifying a measurement target neighbor cell based on the neighbor cell information;
determining information on a service area of the measurement target neighbor cell based on the terrestrial service area information; and
triggering cell measurement based on a location of the terminal and the information on the service area of the measurement target neighbor cell.

2. The method according to claim 1, wherein the obtaining of the terrestrial service area information comprises:
receiving, from the non-terrestrial base station, a system information block (SIB) including the terrestrial service area information for application of the cell measurement relaxation method; and
obtaining the terrestrial service area information from the SIB.

3. The method according to claim 1, wherein the obtaining of the terrestrial service area information comprises:
receiving, from the non-terrestrial base station, a signal including the terrestrial service area information for application of the cell measurement relaxation method through a dedicated channel; and
obtaining the terrestrial service area information from the signal.

4. The method according to claim 3, further comprising, before the receiving of the signal including the terrestrial service area information,
receiving, from the non-terrestrial base station, support indication information indicating that the cell measurement relaxation method is supported and
transmitting, to the non-terrestrial base station, terminal capability information indicating that the terminal supports the cell measurement relaxation method.

5. The method according to claim 1, wherein the neighbor cell information includes identification information of each neighbor cell and information on a priority of each neighbor cell, and the identifying of the measurement target neighbor cell comprises:
identifying a priority of a frequency used by the non-terrestrial base station; and
identifying a neighbor cell using a frequency with a higher priority than the priority of the frequency used by the non-terrestrial base station from the neighbor cell information as the measurement target neighbor cell.

6. The method according to claim 1, further comprising, when the neighbor cell information includes cell type information of each neighbor cell, obtaining cell type information of the measurement target neighbor cell, wherein the determining of the information on the service area of the measurement target neighbor cell is performed when the obtained cell type information of the measurement target neighbor cell indicates that the measurement target neighbor cell is a terrestrial cell.

7. The method according to claim 1, further comprising, when the neighbor cell information includes information on service areas for neighbor cells that are terrestrial cells, searching for information on the service area of the measurement target neighbor cell from the neighbor cell information, wherein the determining of the information on the service area of the measurement target neighbor cell is performed when the information on the service area of the measurement target neighbor cell is searched.

8. The method according to claim 1, wherein the terrestrial service area information includes identification information of each terrestrial service area, information on a center location of each terrestrial service area, information on a radius of each terrestrial service area, and information on a threshold of each terrestrial service area, and the triggering of the cell measurement comprises:
determining the location of the terminal;
determining a center location, radius, and threshold of the terrestrial service area information related to the measurement target neighbor cell;
determining whether the location of the terminal is within the threshold from the center location of the service area related to the measurement target neighbor cell, based on the center location and radius of the terrestrial service area information related to the measurement target neighbor cell; and
triggering the cell measurement when the location of the terminal is within the threshold from the center location of the service area related to the measurement target neighbor cell.

9. The method according to claim 8, wherein the threshold is a threshold distance or a threshold altitude.

10. The method according to claim 9, wherein the threshold altitude is a fixed threshold altitude that is fixed regardless of a distance from the central location of the service area, or a variable threshold altitude that varies depending on the distance from the central location of the service area.

11. The method according to claim 1, wherein in the triggering of the cell measurement, cell measurement is skipped when the terminal is not located in or close to the service area related to the measurement target neighbor cell and is in an idle state or inactive state.

12. A method of a non-terrestrial base station, comprising:
transmitting, to a terminal, terrestrial service area information including information on a service area of a measurement target neighbor cell for application of a cell measurement relaxation method;
transmitting, to the terminal, neighbor cell information including information on the measurement target neighbor cell; and
receiving, from the terminal, a measurement result measured for the measurement target neighbor cell based on the terrestrial service area information and the neighbor cell information.

13. The method according to claim 12, wherein the non-terrestrial base station transmits the terrestrial service area information for application of the cell measurement relaxation method to the terminal through a system information block (SIB).

14. The method according to claim 12, further comprising:
transmitting, to the terminal, support indication information indicating that the cell measurement relaxation method is supported; and
receiving, from the terminal, terminal capability information indicating that the terminal supports the cell measurement relaxation method,
wherein the non-terrestrial base station transmits the terrestrial service area information for application of the cell measurement relaxation method to the terminal through a dedicated channel.

15. The method according to claim 12, wherein the terrestrial service area information includes identification information of each terrestrial service area, information on a center location of each terrestrial service area, information on a radius of each terrestrial service area, and information on a threshold of each terrestrial service area.

16. The method according to claim 12, wherein the neighbor cell information includes at least one of cell identification information for each neighbor cell, non-terrestrial cell indication information for each neighbor cell, terrestrial cell indication information for each neighbor cell, information on a service area to which each neighbor cell belongs, information on a frequency for each neighbor cell, information on an operator for each neighbor cell, or information on a priority for each neighbor cell.

17. A terminal comprising a processor, wherein the processor causes the terminal to perform:
obtaining, from a non-terrestrial base station, terrestrial service area information for application of a cell measurement relaxation method;
receiving neighbor cell information from the non-terrestrial base station;
identifying a measurement target neighbor cell based on the neighbor cell information;
determining information on a service area of the measurement target neighbor cell based on the terrestrial service area information; and
triggering cell measurement based on a location of the terminal and the information on the service area of the measurement target neighbor cell.

18. The terminal according to claim 17, wherein in the obtaining of the terrestrial service area information, the processor further causes the terminal to perform:
receiving, from the non-terrestrial base station, a system information block (SIB) including the terrestrial service area information for application of the cell measurement relaxation method; and
obtaining the terrestrial service area information from the SIB.

19. The terminal according to claim 17, wherein in the obtaining of the terrestrial service area information, the processor further causes the terminal to perform:
receiving, from the non-terrestrial base station, a signal including the terrestrial service area information for application of the cell measurement relaxation method through a dedicated channel; and
obtaining the terrestrial service area information from the signal.

20. The terminal according to claim 17, wherein in the triggering of the cell measurement, the processor may further cause the terminal to skip cell measurement when the terminal is not located in or close to the service area related to the measurement target neighbor cell and is in an idle state or inactive state.
